(19) United States
(12) Patent Application Publication
(10) Pub. No.: US 2012/0034453 A1
(43) Pub. Date: Feb. 9, 2012

(54) LAYER AND STRUCTURE USING COMPOSITION OF CONDUCTIVE POLYMERS

(75) Inventors: Jin Hwan Kim, Gyeonggi-do (KR); In Sook Ahn, Gyeonggi-do (KR); Hee Dong Son, Seoul (KR); Dae Gi Ryu, Gyeonggi-do (KR)

(73) Assignee: SKC CO., LTD., Gyeonggi-do (KR)

(21) Appl. No.: 13/140,205

(22) PCT Filed: Jan. 5, 2010
(86) PCT No.: PCT/KR10/00023

§ 371 Date: Jun. 16, 2011

(30) Foreign Application Priority Data
Jan. 16, 2009 (KR) 10-2009-0003863

(51) Int. Cl. B32B 5/00; B32B 27/08

(52) U.S. Cl. 428/336; 428/419

(57) ABSTRACT

Provided are a polymer layer using a conductive polymer solution composition and a film or sheet structure using the polymer layer. On a film or sheet substrate, an organic polymer layer of polyurethane, acryl, polyester or melamine with superior flexibility and durability is formed, and then a polythiophene-based conductive polymer layer including an aqueous solution of a polythiophene-based conductive polymer, an alcohol organic solvent, an amide organic solvent or an aprotic highly dipolar solvent and a binder selected from melamine resin, polyester, polyurethane, polyacryl resin and alkoxysilane is formed thereon. The resulting layer has high conductivity and high transparency as well as strong moisture resistance and durability. Since surface transparency and conductivity are sustained even under hot and humid environment, it is usefully applicable as upper and lower electrode film of a touch panel, electrode film of an inorganic electroluminescent (EL) device of a mobile phone, transparent electrode film of a display device or electromagnetic interference (EMI) shielding layer of a TV or a PC monitor

### TECHNICAL FIELD

The present invention relates to a polymer layer using a conductive polymer solution composition and a structure thereof.

### Background Art

Conductive polymer compounds that are widely used at present include polyaniline (PANI), polypyrrole (PPy) and polythiophene (PT). Intensive research has been conducted on these compounds because of easy polymerization and superior conductivity, thermal stability and oxidative stability.

Because of their superior electrical properties, applicability of these conductive polymer compounds for various purposes, including electrode of secondary cell, electromagnetic interference (EMI) shielding material, flexible electrode, antistatic material, anticorrosive coating, etc. However, there is difficulty in commercialization because of difficulty in processing, thermal and atmospheric stability, environment resistance, cost, and so on.

Recently, as need on dust-proof and antistatic coating materials increases and industrial standards on EMI shielding become stricter, they are gaining attentions as coating material for EMI shielding in electronic devices.

In particular, conductive polymers began to draw attentions as conductive coating material on glass surface of the Braun tube since the polythiophene-based conductive polymer polyethylene dioxythiophene (PEDT) caught attentions as disclosed in U.S. Pat. Nos. 5,035,926 and 5,391,472. The conductive polymer exhibits better transparency than other conductive polymers such as polyanilines, polypyrroles and polythiophenes.

Conventionally, PEDT was prepared into a water-dispersible coating solution to improve conductivity, with a polymer acid salt such as polystyrene sulfonate as a dopant. Because of excellent compatibility with alcohol solvents and processability, it could be used as coating materials in various applications, including glass surface of the Braun tube (CRT), plastic film surface, or the like.

A typical example of such water-dispersible PEDT is “Clevios P”, which is commercially available from H.C. Starck. Although the PEDT conductive polymer has superior transparency, it needs to be coated at a low concentration to accomplish high transparency of 95% or above. Thus, it is difficult to attain a high conductivity of less than 1 kΩ/m² by an ordinary method. Further, if a silica sol prepared from alkoxysilane [RSi(OR₁)₃] (wherein R represents methyl, ethyl, propyl or isobutyl and R₁ represents methyl or ethyl) is added to increase layer adhesivity, conductivity is further decreased because of the non-conductive silica sol. As a result, it is almost impossible to attain a conductive layer with conductivity less than 1 kΩ/m². For this reason, the water-dispersible PEDT is only used as antistatic coating material requiring low conductivity. In addition, since H. C. s Clevios P is an aqueous dispersion and because it has the SO₃⁻ group, the resultant polymer layer is very susceptible to water. Hence, when left alone for a long time or exposed to harsh environments of high temperature and humidity, the polymer layer experiences severe change in electrical property and transparency.

Korean Patent Publication No. 2000-10221 discloses a conductive polymer composition including PEDT, an alcohol solvent, an amide solvent and a polyester resin binder, and Korean Patent Publication No. 2005-66209 discloses a conductive light diffusion film coating composition including PEDT, an alcohol solvent, an amide solvent and a silane coupling agent.

Although they provide good electrical property of less than 1 kΩ/m² as well as high transparency, strong adhesivity and good durability, they also experience severe change in electrical property and transparency when left alone for a long time or exposed to harsh environments of high temperature and humidity. Further, they experience severe change in transparency during a high temperature process (120° C. or above) in the manufacture of touch panel devices or other display devices because of oligomer protrusion from the substrate. Because of these problems, it is almost impossible to accomplish an EMI shielding standard (TCO certification) satisfying surface resistance of 1 kΩ/m² or lower, as well as good moisture resistance, adhesivity and durability and high transparency under harsh environment of high temperature and humidity, for use as electrode film of a touch panel in a personal digital assistant (PDA) or a car navigation system or an inorganic electroluminescent (EL) device of a mobile phone and as transparent electrode film in a display electrode.

### SUMMARY OF INVENTION

### Technical Problem

An object of the present invention is to provide a polymer layer using a polythiophene-based conductive polymer solution composition capable of providing improved conductivity and transparency as well as superior moisture resistance, adhesivity, durability, layer uniformity, solution stability and sustained transparency under hot and humid environment, and a structure thereof.

### Solution to Problem

The present invention provides a polythiophene-based conductive polymer layer, wherein an organic polymer layer is formed between a conductive polymer layer and a substrate, having a conductivity of 1 kΩ/m² or lower, a transmittance of 95% or higher, high durability and, in particular, sustained electrical property and transparency under hot and humid environment, and a structure thereof.

### Advantageous Effects of Invention

The polymer layer using a polythiophene-based conductive polymer solution composition according to the present invention is applicable as upper and lower electrode film of a touch panel, electrode film of an inorganic electroluminescent (EL) device of a mobile phone, transparent electrode film of a display device or electromagnetic interference (EMI) shielding layer of a TV or a computer monitor, which requires a conductivity of 1 kΩ/m² or lower, a transmittance of 95% or higher, strong moisture resistance and durability and sustained transparency under hot and humid environment. It is also applicable to other glass, polycarbonate acryl, polyethylene terephthalate or cast polypropylene (CPP) film.

### BRIEF DESCRIPTION OF DRAWINGS

The above and other objects, features and advantages of the present invention will become apparent from the following description of preferred embodiments given in conjunction with the accompanying drawings, in which:

FIG. 1 shows a setup for measuring contact resistance of a polymer layer according to the present invention;

FIG. 2 shows a structure of a film for a touch panel or a display electrode according to the present invention; and

FIG. 3 shows SEM micrographs of a film according to the present invention with prevented oligomer protrusion [(1) shows oligomer protrusion formed on a polythiophene-based conductive polymer layer with no organic polymer layer; and (2) shows a polythiophene-based conductive polymer layer with an organic polymer layer (high-temperature treatment: 10 minutes at 125° C., PET film: products available from SKC, Toray and Toyobo)].

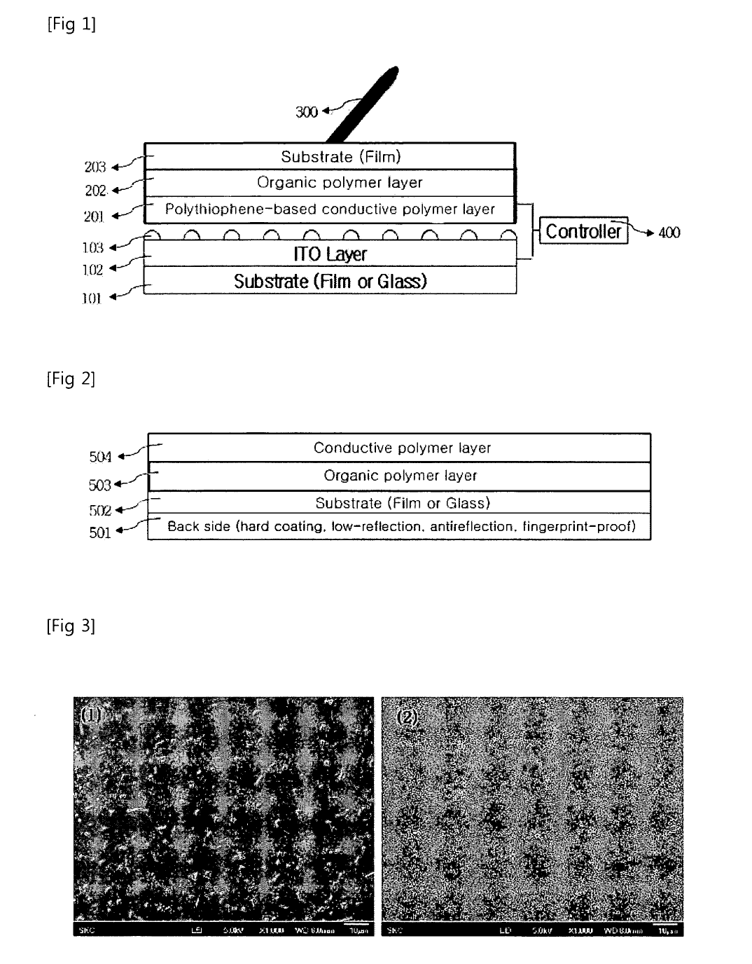

### BEST MODE FOR CARRYING OUT THE INVENTION

Hereinafter, the embodiments of the present invention will be described in detail with reference to accompanying drawings.

The present invention relates to a polythiophene-based conductive polymer layer with a polythiophene-based conductive polymer layer is formed on a substrate, wherein an organic polymer layer is formed between the substrate and the polythiophene-based conductive polymer layer. Preferably, the polythiophene-based conductive polymer layer includes melamine resin.

To solve the problems of the existing conductive layer, the inventors of the present invention have made efforts to provide a polythiophene-based conductive polymer layer having high conductivity as well as high transparency, strong moisture resistance and durability and sustained transparency under harsh environments of high temperature and high humidity. They could achieve the object by preparing a polymer solution composition comprising an aqueous solution of a polythiophene-based conductive polymer, an alcohol organic solvent, an amide organic solvent or an aprotic highly dipolar solvent and a binder selected from melamine resin, polyester, polyurethane, polyacryl resin and alkoxysilane and providing an organic polymer solution composition of polyester, acryl, urethane or melamine between a polymer layer prepared from the conductive polymer solution composition and a substrate.

The amide organic solvent or the aprotic highly dipolar solvent of the conductive polymer solution composition partly redissolves the polymer group of the aqueous solution of the polythiophene-based conductive polymer, thereby improving connection between and dispersibility of the polythiophene-based conductive polymers. And the NH⁺ group of the melamine resin binds with the SO₃⁻ group in the aqueous solution of the polythiophene-based conductive polymer (Clevios P), thereby preventing the SO₃⁻ group from reacting with water. As a result, moisture resistance and electrical stability are improved. And, the binder improves adhesivity with the transparent substrate and durability of the conductive layer. When the organic polymer layer of polyester, polyacryl, polyurethane or melamine is provided between the layer coated with the conductive polymer solution composition and the substrate and the resultant polyethylene terephthalate film or polycarbonate sheet is treated at high temperature, oligomer protrusion is prevented, conductivity and transparency are improved, and superior moisture resistance, adhesivity, durability, layer uniformity, solution stability and, in particular, sustained transparency under hot and humid environment are attained.

In the polythiophene-based conductive polymer layer according to the present invention, the organic polymer layer may comprise one or more organic polymer(s) selected from polyester, polyacryl, polyurethane and melamine resin.

Preferably, in the polythiophene-based conductive polymer layer of the present invention, the organic polymer layer has a thickness of 0.5 to 20 μm.

The polythiophene-based conductive polymer layer may be prepared from a polythiophene-based conductive solution composition comprising: 20 to 70 wt % of an aqueous solution of a polythiophene-based conductive polymer; 10 to 75 wt % of an alcohol organic solvent; 1 to 10 wt % of an amide organic solvent or an aprotic highly dipolar solvent; and 0.1 to 15 wt % of one or more binder(s) selected from polyester, polyurethane, alkoxysilane and melamine resin.

Preferably, the aqueous solution of the polythiophene-based conductive polymer may be polyethylene dioxythiophene (PEDT) doped with polystyrene sulfonate.

More preferably, the aqueous solution of the polythiophene-based conductive polymer has a solid content of 1.0 to 1.5 wt %.

In the polythiophene-based conductive polymer layer according to the present invention, the alcohol organic solvent may be a C₁-C₄ alcohol.

And, in the polythiophene-based conductive polymer layer according to the present invention, the amide organic solvent may be one or more selected from the group consisting of formamide, N-methylformamide, N,N-dimethylformamide, acetamide, N-methylacetamide, N-dimethylacetamide and N-methylpyrrolidone.

In the polythiophene-based conductive polymer layer according to the present invention, the aprotic highly dipolar solvent may be one or more selected from dimethylsulfoxide and propylene carbonate.

Preferably, when the aprotic highly dipolar solvent is used, a dispersion stabilizer may be added in an amount of 1 to 10 wt % based on the polythiophene-based conductive solution composition.

And, in the polythiophene-based conductive polymer layer according to the present invention, the dispersion stabilizer may be one or more selected from ethylene glycol, glycerine and sorbitol.

Preferably, in the polythiophene-based conductive polymer layer according to the present invention, the binder is one or more selected from methyltrimethoxysilane and tetraethoxysilane.

Hereinafter, the present invention will be described in more detail.

The present invention relates to a polymer layer using a polythiophene-based conductive polymer composition comprising an aqueous solution of a polythiophene-based conductive polymer, an alcohol organic solvent, an amide organic solvent or an aprotic highly dipolar solvent and a binder selected from melamine resin, polyester, polyurethane, polyacryl resin and alkoxysilane, and an organic polymer layer comprising polyester, polyacryl, polyurethane or melamine between the conductive polymer layer and a substrate.

Specifically, in addition to an aqueous solution of a polythiophene-based conductive polymer and an alcohol organic solvent, which are used in the existing art, an amide organic solvent or an aprotic highly dipolar solvent, which partly redissolves the polymer group of the aqueous solution of the polythiophene-based conductive polymer, thereby improving connection between and dispersibility of the polythiophene-based conductive polymers, melamine resin, the NH⁺ group of which binds with the SO₃⁻ group in the aqueous solution of the polythiophene-based conductive polymer (Clevios P), thereby preventing the SO₃⁻ group from reacting with water and improving moisture resistance and electrical stability, and a binder selected from polyester, polyurethane, polyacryl resin and alkoxysilane, which improves adhesivity with the transparent substrate and durability of the conductive layer, are added. As a result, the resulting conductive layer has strong durability and the polythiophene-based conductive composition provides improved conductivity and transparency as well as superior moisture resistance, adhesivity, durability, layer uniformity and solution stability without a stabilizer of the sulfonate group for connecting the polythiophene-based conductive polymers. When the organic polymer layer of polyester, polyacryl, polyurethane or melamine is provided between the layer coated with the conductive polymer solution composition and the substrate and the resultant polyethylene terephthalate film or polycarbonate sheet is treated at high temperature, oligomer protrusion is prevented, conductivity and transparency are improved, and superior moisture resistance, adhesivity, durability, layer uniformity, solution stability and, in particular, sustained transparency under hot and humid environment are attained.

When the polythiophene-based conductive polymer solution composition and the organic polymer solution composition of polyester, polyacryl, polyurethane or melamine are coated on a transparent substrate such as glass or synthetic resin film, a superior layer with a conductivity of 1 kΩ/m2 or less, preferably 100 Ω/m2 to 1 kΩ/m2, a transparency of 95% or higher, preferably 95 to 99%, as well as superior moisture resistance, adhesivity, durability, layer uniformity, solution stability and, in particular, sustained transparency even under hot and humid environment may be obtained. The conductivity of 1 kΩ/m2 or less satisfies the strict Tianstemanners Central Organization (TCO) certification for electromagnetic interference (EMI) shielding by the Swedish Confederation of Professional Employees.

The constituents of the polythiophene-based conductive polymer composition according to the present invention will be described in more detail hereinbelow.

The aqueous solution of a polythiophene-based conductive polymer may be one commonly used in the art and is not particularly limited. Preferably, PEDT may be used. Specifically, the Clevios P product available from H.C. Starck may be used. Since PEDT is doped with polystyrene sulfonate (PSS) as a stabilizer (dopant), it is highly soluble in water and has very superior thermal and atmospheric stability. To maintain optimized dispersibility in water, the solid content of PEDT and PSS is adjusted to be 1.0 to 1.5 wt %. Because PEDT is compatible with water, alcohol or other solvents with a large dielectric constant, it may be easily coated as diluted in such solvents. Even after a coating film has been formed, the polythiophene-based conductive polymer has better transparency than other conductive polymers such as polyaniline or polypyrrole.

The aqueous solution of the polythiophene-based conductive polymer is used in an amount of 20 to 70 wt %, preferably 26 to 67 wt %. If it is used in an amount less than 20 wt %, it is difficult to attain a high conductivity of 1 kΩ/m² or less even when the amount of the amide organic solvent or the aprotic highly dipolar solvent is increased. Meanwhile, if the aqueous solution of the polythiophene-based conductive polymer is used in an amount exceeding 70 wt %, transmittance, particularly in the long-range region of the visible spectrum (550 nm or higher), decreases to 95% or below.

The alcohol organic solvent may be a C₁-C₄ alcohol, specifically one or more selected from methanol, ethanol, propanol, isopropanol and butanol. Preferably, methanol may be used as a main solvent in order to improve dispersibility of the PEDT conductive polymer.

The alcohol is used in an amount of 10 to 75 wt %. When used together with the amide organic solvent, it is preferably used in an amount of 10 to 71 wt %, more preferably 24 to 70 wt %. When used together with the aprotic highly dipolar solvent, it is preferably used in an amount of 5 to 68 wt %, more preferably 20 to 62 wt %. If the alcohol is used in an amount less than 10 wt %, high conductivity may be attained because of decreased dispersibility, but transmittance decreases. And, if it is used in an amount exceeding 75 wt %, dispersibility is good, but conductivity decreases and coagulation occurs easily.

Preferably, the amide organic solvent may be one or more selected from formamide (FA), N-methylformamide (NMFA), N,N-dimethylformamide (DMF), acetamide (AA), N-methylacetamide (NMAA), N-dimethylacetamide (DMA) and Nmethylpyrrolidone(NMP). The amide organic solvent commonly has an amide group [R(CO)NR₂] (wherein R is H, CH₃—, or CH₃CH₂CH₂—) in the molecule. The amide organic solvent may alone improve conductivity when added to the PEDT conductive polymer. However, it is preferred that two or more of the amide organic solvents are added together to accomplish a surface resistance of 1 kΩ/m² or lower and a transparency of 95% or higher.

The aprotic highly dipolar (AHD) solvent may be specifically dimethyl sulfoxide (DMSO), propylene carbonate, or the like. The aprotic highly dipolar solvent and the amide organic solvent should be used separately. When they are mixed, high transparency and long-term solution stability cannot be obtained, with little synergistic effect on conductivity.

When the aprotic highly dipolar solvent is used alone, improvement of conductivity is not significant. To improve conductivity, it is preferred to use it together with one or more dispersion stabilizer(s) selected from ethylene glycol (EG), glycerine and sorbitol. The dispersion stabilizer is used in an amount of 1 to 10 wt %, preferably 4 to 10 wt %, based on the polythiophene-based conductive polymer solution composition. If it is used in an amount less than 1 wt %, high conductivity cannot be attained. And, if it is used in an amount exceeding 10 wt %, high-temperature baking may be required because of increased boiling point although conductivity is improved.

The amide organic solvent is used in amount of 1 to 10 wt %, preferably 3 to 7 wt %, and the aprotic highly dipolar solvent is used in amount of 1 to 10 wt %, preferably 4 to 8 wt %. Below the lower limits, improvement of conductivity may be insufficient. And, above the upper limits, although conductivity is improved, high-temperature baking may be required because of increased boiling point, which may negatively affect the conductivity of the PEDT conductive polymer and, in case of plastic substrates other than glass, result in deformation of the substrate.

The PEDT conductive polymer solution comprises a water-soluble or alcohol-soluble polymer resin as a binder to provide moisture resistance, substrate adhesivity and durability. Since the PEDT conductive polymer solution itself is an aqueous dispersion, a resin in an aqueous solution state is preferred. However, because the PEDT conductive polymer solution has SO₃⁻ groups in the solution, use of a binder in an aqueous solution state may result in reduced moisture resistance. Therefore, in the present invention, melamine resin is added to provide strong moisture resistance. The NH⁺ group of the melamine resin binds with the SO₃⁻ group in the aqueous solution of the polythiophene-based conductive polymer, thereby preventing the SO₃⁻ group from reacting with water. As a result, moisture resistance and electrical stability are improved.

The melamine resin is used in an amount of 1 to 10 wt %, preferably 1 to 8 wt %. If it is used in an amount less than 1 wt %, the conductive layer may have poor moisture resistance. If it is used in an amount exceeding 10 wt %, the moisture resistance is very superior, but improvement of conductivity may be interfered.

Specifically, the binder for improving adhesivity to the transparent substrate and durability may be one or more selected from polyester, polyurethane, polyacryl and alkoxysilane. To provide a stronger adhesivity, it is preferred to use two or more of them. In particular, when coating on a polyethylene terephthalate film, it is preferred to use polyester resin in order to improve adhesivity to the substrate. The binder is used in an amount of 0.1 to 5 wt %, preferably 0.5 to 4 wt %. If it is used in an amount less than 0.1 wt %, adhesivity to the substrate and durability of the conductive layer may be insufficient. And, if it is used in an amount exceeding 5 wt %, improvement of conductivity may be interfered. The polyester, polyurethane or polyacryl used as the binder may be any one commonly used in the art. The alkoxysilane may be preferably a tertiary or quaternary silane compound, more preferably trimethoxysilane or tetraethoxysilane.

In addition, an additive for improving slip or reducing viscosity may be added in an amount of 0.05 to 5 wt % based on 100 wt % of the conductive polymer solution composition, in order to prevent blocking or improve slip on the coated surface.

The thickness of the organic polymer composition layer of polyester, polyacryl, polyurethane or melamine formed between the polythiophene-based conductive polymer layer and the substrate is important with respect to sustained transparency under hot and humid environment. In general, oligomers formed on the substrate under high-temperature environment of 100° C. or above have a size of 0.5 to 10 μm. Therefore, it is preferred that the organic polymer layer has a thickness of 0.5 to 20 μm, preferably 1 to 10 μm. The presence of protruding oligomers results in increased haze of the polymer layer and decreased transparency. If the thickness is smaller than 0.5 μm, oligomer protrusion occurring tat high temperature cannot be prevented. Meanwhile, if the thickness exceeds 20 μm, high-temperature baking may be required for drying, which may result in deformation of the substrate.

The polyester, polyacryl, polyurethane or melamine used in the organic polymer layer formed between the polythiophene-based conductive polymer layer and the substrate may be any one commonly used in the art. To provide stronger adhesivity and durability, it is preferred to use the same substance as the organic binder comprised in the conductive polymer solution composition.

A method for preparing the polythiophene conductive polymer solution composition according to the present invention with high conductivity and transparency, strong moisture resistance and durability and sustained transparency under hot and humid environment and the layer using the same may be one commonly used in the art and is not particularly limited. The preparation method may be largely distinguished into: forming an organic polymer layer between a conductive polymer layer to which an amide organic solvent has been added and a substrate; and forming an organic polymer layer between a conductive polymer layer to which an aprotic highly dipolar solvent has been added and a substrate.

When the solution composition is coated on the glass surface of the Braun tube (TV or PC) or on the surface of a transparent substrate such as cast polypropylene (CPP) film, polyethylene terephthalate film, polycarbonate or acryl panel, etc. and dried in an oven of about 100 to 145° C. for about 1 to 10 minutes, a polythiophene polymer layer for EMI shielding and electrode with high transparency and high conductivity is obtained. The coating may be carried out by bar coating, roll coating, flow coating, dip coating, spin coating, etc. The dried film of the organic polymer solution has a thickness of 20 μm or less, and the film of the conductive polymer solution has a thickness of 5 μm or less.

The resulting polymer layer and its structure may be applied to antistatic and EMI shielding applications satisfying the TCO certification, as well as a touch panel in a personal digital assistant (PDA) or a car navigation system or an inorganic electroluminescent (EL) device of a mobile phone and as transparent electrode film in a display electrode, which require high conductivity and transparency, strong moisture resistance and durability and sustained transparency under hot and humid environment.

### MODE FOR THE INVENTION

The examples and experiments will now be described. The following examples and experiments are for illustrative purposes only and not intended to limit the scope of this disclosure.

### Comparative Examples 1-9

### Conductive Polymer Substrate with No Organic Polymer Layer Introduced (Amide Organic Solvent)

While vigorously stirring each aqueous solution of PEDT conductive polymer given in Table 1, an alcohol solvent, an amide organic solvent, melamine resin, a binder, a stabilizer, and an additive for improving slip or reducing viscosity were added sequentially with intervals of about 7 minutes. After uniform mixing for about 4 hours, a solution composition was prepared.

The resulting solution composition was coated on a transparent substrate with no organic polymer layer. Then, after drying in an oven of about 125° C. for about 5 minutes, a polythiophene polymer layer was prepared. The dried polymer layer had a thickness not greater than 5 μm.

TABLE 1

| | Organic | | | | | |
|---|---|---|---|---|---|---|
| | polymer layer | Aqueous | | Amide | | |
| | (thickness: | PEDT | | organic | Melamine | |
| | μm) | solution | Alcohol | solvent | resin | Binder |
| Comp. | — | 26 | MeOH | FA | Melamine | R-986 (1) |
| Ex. 1 | | | (68) | (3)NMP | (1) | |
| | | | | (1) | | |
| Comp. | | 37 | MeOH | FA | Melamine | PET(aq) (1) |
| Ex. 2 | | | (56) | (2)NMP | (3) | |
| | | | | (1) | | |
| Comp. | | 46.2 | MeOH | FA | Melamine | — |
| Ex. 3 | | | (45.8) | (3)NMP | (3) | |
| | | | | (2) | | |
| Comp. | | 46.2 | MeOH | FA | — | A-187 (2) |
| Ex. 4 | | | (47.8) | (3)NMP | | |
| | | | | (1) | | |
| Comp. | | 46.2 | MeOH | FA | — | R-986 (3) |
| Ex. 5 | | | (47.8) | (2)NMP | | |
| | | | | (1) | | |
| Comp. | | 46.2 | MeOH | FA | — | — |
| Ex. 6 | | | (49.8) | (3)NMP | | |
| | | | | (1) | | |
| Comp. | | 54.6 | MeOH | FA | — | A-187 (5) |
| Ex. 7 | | | (37.4) | (2)NMP | | |
| | | | | (1) | | |
| Comp. | | 54.6 | MeOH | FA | — | — |
| Ex. 8 | | | (42.4) | (2)NMP | | |
| | | | | (1) | | |
| Comp. | | 60 | MeOH | FA | — | TEOS (5) |
| Ex. 9 | | | (32) | (2)NMP | | |
| | | | | (1) | | |

PEDT: polyethylene dioxythiophene (H. C. Starck), solid content: 1.0 to 1.5%MeOH: methyl alcohol (Aldrich)FA: formamide (Aldrich)PET(aq): aqueous solution of polyethylene terephthalate with 20% solid content (SKC)R-986: aqueous solution of polyurethane with 25% solid content (DSM)NMP: N-methylpyrrolidone (Aldrich)A-187: γ-glycidoxypropyltrimethoxysilane (Degussa)Melamine resin: Aldrich, solid content = 90%TEOS: tetraethoxysilane (Aldrich)
(Unit: g)

### Examples 1-5

### Conductive Polymer Substrate with Organic Polymer Layer (Amide Organic Solvent)

A conductive polymer solution composition was prepared in the same manner as Comparative Example 1 (see Table 2).

First, an organic polymer layer of polyester, polyacryl or polyurethane was coated on a transparent substrate. After drying in an oven of about 125° C. for about 5 minutes, a conductive polymer solution composition was coated on the organic polymer layer. Then, after drying in an oven of about 125° C. for about 5 minutes, a polythiophene-based polymer layer was prepared. The dried conductive polymer layer had a thickness not greater than 5 μm.

TABLE 2

| | Organic | | | | | |
|---|---|---|---|---|---|---|
| | polymer layer | Aqueous | | Amide | | |
| | (thickness: | PEDT | | organic | Melamine | |
| | μm) | solution | Alcohol | solvent | resin | Binder |
| Ex. 1 | R-986 (0.7) | 26 | MeOH | FA | Melamine | R-986 (2) |
| | | | (66) | (2)NMP | (3) | |
| | | | | (1) | | |
| Ex. 2 | R-961 (2.0) | 26 | EtOH | FA | Melamine | PET(aq) (1) |
| | | | (69.0) | (2)NMP | (1) | |
| | | | | (1) | | |
| Ex. 3 | PET(aq) (5.0) | 26 | MeOH | FA | Melamine | HY-570 (2) |
| | | | (61) | (1)NMP | (4) | |
| | | | | (2)NMAA | | |
| | | | | (4) | | |
| Ex. 4 | HY-570 (9.0) | 46.2 | MeOH | FA | Melamine | R-961 (3) |
| | | | (44.8) | (2)NMP | (3) | |
| | | | | (1) | | |
| Ex. 5 | Melamine | 60 | MeOH | FA | Melamine | A-187 (3) |
| | (20.0) | | (28) | (2)NMP | (6) | |
| | | | | (1) | | |
| Comp. | PET(aq) (25.0) | 46.2 | EtOH | FA | — | — |
| Ex. 10 | | | (49.8) | (3)NMP | | |
| | | | | (1) | | |
| Comp. | HY-570 (0.4) | 46.2 | EtOH | FA | — | PET(aq) |
| Ex. 11 | | | (45.8) | (2)NMP | | (3)TEOS |
| | | | | (1) | | (2) |
| Comp. | R-986 (0.3) | 46.2 | EtOH | FA | — | PET(aq) |
| Ex. 12 | | | (45.8) | (2)NMP | | (4)R-961 |
| | | | | (1) | | (1) |

PEDT: polyethylene dioxythiophene (H. C. Starck), solid content: 1.0 to 1.5%MeOH: methyl alcohol (Aldrich)FA: formamide (Aldrich)PET(aq): aqueous solution of polyethylene terephthalate with 20% solid content (SKC)NMP: N-methylpyrrolidone (Aldrich)A-187: γ-glycidoxypropyltrimethoxysilane (Degussa)R-986: aqueous solution of polyurethane with 25% solid content (DSM)R-961: aqueous solution of polyurethane with 34% solid content (DSM)HY-570: aqueous solution of polyacryl with 40% solid content (Air Products)Melamine resin: Aldrich, solid content = 90%TEOS: tetraethoxysilane (Aldrich)
(Unit: g)

### Comparative Examples 10-12

### Conductive Polymer Substrate with Organic Polymer Layer and with No Melamine (Amide Organic Solvent)

A conductive polymer solution composition was prepared in the same manner as Comparative Example 1 (see Table 2).

First, an organic polymer layer of polyester, polyacryl or polyurethane was coated on a transparent substrate. After drying in an oven of about 125° C. for about 5 minutes, a conductive polymer solution composition was coated on the organic polymer layer. Then, after drying in an oven of about 125° C. for about 5 minutes, a polythiophene-based polymer layer was prepared. The dried conductive polymer layer had a thickness not greater than 5 μm.

### Examples 6-9

### Conductive Polymer Substrate with Organic Polymer Layer (Aprotic Highly Dipolar Solvent)

A conductive polymer solution composition was prepared in the same manner as Comparative Example 1 (see Table 3).

First, an organic polymer layer of polyester, polyacryl or polyurethane was coated on a transparent substrate. After drying in an oven of about 125° C. for about 5 minutes, a conductive polymer solution composition was coated on the organic polymer layer. Then, after drying in an oven of about 125° C. for about 5 minutes, a polythiophene-based polymer layer was prepared. The dried conductive polymer layer had a thickness not greater than 5 μm.

TABLE 3

| | Organic | | | Aprotic | | | |
|---|---|---|---|---|---|---|---|
| | polymer layer | Aqueous | | highly | | | |
| | (thickness: | PEDT | | dipolar | Dispersion | Melamine | |
| | μm) | solution | Alcohol | solvent | stabilizer | resin | Binder |
| Ex. 6 | PET(aq) | 26 | MeOH | DMSO | EG (6) | Melamine | A-187 |
| | (1.0) | | (59) | (4) | | (2) | (3) |
| Ex. 7 | Melamine | 46 | MeOH | DMSO | EG (6) | Melamine | R-961 |
| | (2.5) | | (41) | (4) | | (1) | (2) |
| Ex. 8 | R-961 | 50 | MeOH | DMSO | EG (7) | Melamine | HY-570 |
| | (7.0) | | (33) | (5) | | (2) | (3) |
| Ex. 9 | HY-570 | 60 | MeOH | DMSO | EG (6) | Melamine | PET(aq) |
| | (15.0) | | (24) | (4) | | (3) | (3) |
| Comp. | HY-570 | 26 | MeOH | DMSO | EG (8) | — | — |
| Ex. 13 | (0.3) | | (58) | (8) | | | |
| Comp. | R-986 | 46 | MeOH | DMSO | EG (9) | — | — |
| Ex. 14 | (27.0) | | (34) | (10)NMFA | | | |
| | | | | (1) | | | |
| Comp. | Melamine | 50 | MeOH | DMSO | EG (8) | — | R-986 |
| Ex. 15 | (40.0) | | (23) | (10) | | | (3)TEOS |
| | | | | | | | (6) |

PEDT: polyethylene dioxythiophene (H. C. Starck), solid content: 1.0 to 1.5%MeOH: methyl alcohol (Aldrich)FA: formamide (Aldrich)NMFA: N-methylformamide (Aldrich)EG: ethylene glycol (Aldrich)PET(aq): aqueous solution of polyethylene terephthalate with 20% solid content (SKC)NMP: N-methylpyrrolidone (Aldrich)DMSO: dimethylsulfoxide (Aldrich)A-187: γ-glycidoxypropyltrimethoxysilane (Degussa)R-986: aqueous solution of polyurethane with 25% solid content (DSM)R-961: aqueous solution of polyurethane with 34% solid content (DSM)HY-570: aqueous solution of polyacryl with 40% solid content (Air Products)Melamine resin: Aldrich, solid content = 90%TEOS: tetraethoxysilane (Aldrich)
(Unit: g)

### Comparative Examples 13-15

### Conductive Polymer Substrate with Organic Polymer Layer and with No Melamine (Aprotic Highly Dipolar Solvent)

A conductive polymer solution composition was prepared in the same manner as Comparative Example 1 (see Table 3).

First, an organic polymer layer of polyester, polyacryl or polyurethane was coated on a transparent substrate. After drying in an oven of about 125° C. for about 5 minutes, a conductive polymer solution composition was coated on the organic polymer layer. Then, after drying in an oven of about 125° C. for about 5 minutes, a polythiophene-based polymer layer was prepared. The dried conductive polymer layer had a thickness not greater than 5 μm.

Test Example: Physical Property Test

1) Conductivity: Surface resistance was measured using an ohmmeter (Loresta EP MCP-T360, Mitsubish Chemical).

2) Transparency: Transmittance was measured at 550 nm (CM-3500d, Minolta). Transmittance after coating was evaluated relative to a transparent substrate.

3) Adhesivity: After taping 10 times, change in surface resistance was measured (tape: Nitto).

Change in Surface Resistance

i) Not greater than 50 Ω/m²: good

ii) 50 to 100 Ω/m²: moderate

iii) 100 Ω/m² or greater: poor

4) Change in transparency: After the coating and drying, the conductive polymer layer was treated at 125° C. for 10 minutes. Then, the change in haze value due to oligomer protrusion was measure using a hazemeter (NDH 5000W, Nippon Donshoku Kogyo) (initial haze before drying: not greater than 1%).

Change in Haze

i) Not greater than 3%: good

ii) 3% or greater: poor

5) Solution stability: After placing at normal temperature for a week, the presence of coagulation was observed.

6) Dryness of organic polymer layer: After drying at 125° C. for 5 minutes, degree of dryness was evaluated.

i) Completely dry: good

ii) Incompletely dry: poor

The test result is given in Tables 4 to 6.

TABLE 4

| | | | | | | | | Dryness of |
|---|---|---|---|---|---|---|---|---|
| | | | | | | | Haze | organic |
| | Conductivity | Transparency | Moisture | | Layer | Solution | (initial: | polymer |
| | (Ω/m²) | (%) | resistance | Adhesivity | uniformity | stability | 0.5%) | layer |
| Comp. | 710 | 98 | Good | Good | Good | Good | Poor | — |
| Ex. 1 | | | | | | | | |
| Comp. | 650 | 97 | Good | Good | Good | Good | Poor | — |
| Ex. 2 | | | | | | | | |
| Comp. | 400 | 96 | Good | Good | Good | Good | Poor | — |
| Ex. 3 | | | | | | | | |
| Comp. | 380 | 97 | Poor | Good | Good | Good | Poor | — |
| Ex. 4 | | | | | | | | |
| Comp. | 450 | 96 | Poor | Good | Good | Good | Poor | — |
| Ex. 5 | | | | | | | | |
| Comp. | 400 | 96 | Poor | Poor | Good | Good | Poor | — |
| Ex. 6 | | | | | | | | |
| Comp. | 310 | 95 | Poor | Good | Good | Good | Poor | — |
| Ex. 7 | | | | | | | | |
| Comp. | 305 | 95 | Poor | Poor | Good | Good | Poor | — |
| Ex. 8 | | | | | | | | |
| Comp. | 300 | 95 | Poor | Good | Good | Good | Poor | — |
| Ex. 9 | | | | | | | | |

As seen in Table 4, Comparative Examples 1-3 in which melamine resin was used showed better moisture resistance than Comparative Examples 4-9 with no melamine resin. However, after high-temperature treatment, haze increased because of oligomer protrusion.

TABLE 5

| | | | | | | | | Dryness of |
|---|---|---|---|---|---|---|---|---|
| | | | | | | | Haze | organic |
| | Conductivity | Transparency | Moisture | | Layer | Solution | (initial: | polymer |
| | (Ω/m²) | (%) | resistance | Adhesivity | uniformity | stability | 0.5%) | layer |
| Ex. 1 | 800 | 99 | Good | Good | Good | Good | Good | Good |
| Ex. 2 | 750 | 98 | Good | Good | Good | Good | Good | Good |
| Ex. 3 | 770 | 96 | Good | Good | Good | Good | Good | Good |
| Ex. 4 | 390 | 96 | Good | Good | Good | Good | Good | Good |
| Ex. 5 | 320 | 96 | Good | Good | Good | Good | Good | Good |
| Comp. | 370 | 96 | Poor | Poor | Good | Good | Good | Poor |
| Ex. 10 | | | | | | | | |
| Comp. | 380 | 96 | Poor | Good | Good | Good | Poor | Good |
| Ex. 11 | | | | | | | | |
| Comp. | 360 | 96 | Poor | Good | Good | Good | Poor | Good |
| Ex. 12 | | | | | | | | |

As seen in Table 5, Examples 1-5 according to the present invention showed better conductivity and transparency as well as moisture resistance, adhesivity, layer uniformity and solution stability than Comparative Example 10 with no melamine resin and binder and Comparative Examples 11-12 with no melamine resin. In particular, in Examples 1-5, wherein the conductive polymer solution was coated on the organic polymer layer with an adequate thickness, haze was maintained at 3.0% or lower even after high-temperature treatment and the organic polymer layer could be dried without deformation of the substrate. Comparative Examples 10-12 only with the organic polymer showed better physical properties than Comparative Examples 1-9

TABLE 6

| | | | | | | | | Dryness of |
|---|---|---|---|---|---|---|---|---|
| | | | | | | | Haze | organic |
| | Conductivity | Transparency | Moisture | | Layer | Solution | (initial: | polymer |
| | (Ω/m²) | (%) | resistance | Adhesivity | uniformity | stability | 0.5%) | layer |
| Ex. 6 | 880 | 98 | Good | Good | Good | Good | Good | Good |
| Ex. 7 | 380 | 97 | Good | Good | Good | Good | Good | Good |
| Ex. 8 | 330 | 96 | Good | Good | Good | Good | Good | Good |
| Ex. 9 | 280 | 95 | Good | Good | Good | Good | Good | Good |
| Comp. | 760 | 98 | Poor | Poor | Good | Good | Poor | Good |
| Ex. 13 | | | | | | | | |
| Comp. | 500 | 96 | Poor | Poor | Good | Poor | Good | Poor |
| Ex. 15 | | | | | | | | |
| Comp. | 410 | 97 | Poor | Good | Good | Good | Good | Poor |
| Ex. 15 | | | | | | | | |

As seen in Table 6, Examples 6-10 according to the present invention showed better conductivity and transparency as well as adhesivity, layer uniformity, solution stability and, in particular, moisture resistance than Comparative Examples 13-14 with no melamine resin and binder and Comparative Example 15 with no melamine resin. In particular, in Examples 6-9, wherein the conductive polymer solution was coated on the organic polymer layer with an adequate thickness, haze was maintained at 3.0% or lower even after high-temperature treatment and the organic polymer layer could be dried without deformation of the substrate. Comparative Examples 13-15 only with the organic polymer showed better physical properties than Comparative Examples 1-9 (Table 4).

The present application contains subject matter related to Korean Patent Application No. 2009-0003863, filed in the Korean Intellectual Property Office on Jan. 16, 2009, the entire contents of which is incorporated herein by reference.

While the present invention has been described with respect to the specific embodiments, it will be apparent to those skilled in the art that various changes and modifications may be made without departing from the spirit and scope of the invention as defined in the following claims.

1. A polythiophene-based conductive polymer layer with a polythiophene-based conductive polymer layer formed on a substrate, wherein an organic polymer layer is formed between the substrate and the polythiophene-based conductive polymer layer.

2. The polythiophene-based conductive polymer layer according to claim 1, wherein the organic polymer layer comprises one or more organic polymer(s) selected from polyester, polyacryl, polyurethane and melamine resin.

3. The polythiophene-based conductive polymer layer according to claim 1, wherein the organic polymer layer has a thickness of 0.5 to 20 μm.

4. The polythiophene-based conductive polymer layer according to claim 1, wherein the polythiophene-based conductive polymer layer is prepared from a polythiophene-based conductive solution composition comprising: 20 to 70 wt % of an aqueous solution of a polythiophene-based conductive polymer; 10 to 75 wt % of an alcohol organic solvent; 1 to 10 wt % of an amide organic solvent or an aprotic highly dipolar solvent; and 0.1 to 15 wt % of one or more binder(s) selected from polyester, polyurethane, alkoxysilane and melamine resin.

5. The polythiophene-based conductive polymer layer according to claim 4, wherein the aqueous solution of the polythiophene-based conductive polymer is polyethylene dioxythiophene (PEDT) doped with polystyrene sulfonate.

6. The polythiophene-based conductive polymer layer according to claim 4, wherein the aqueous solution of the polythiophene-based conductive polymer has a solid content of 1.0 to 1.5 wt %.

7. The polythiophene-based conductive polymer layer according to claim 4, wherein the alcohol organic solvent is a C₁-C₄ alcohol.

8. The polythiophene-based conductive polymer layer according to claim 4, wherein the amide organic solvent is one or more selected from the group consisting of formamide, N-methylformamide, N,N-dimethylformamide, acetamide, N-methylacetamide, N-dimethylacetamide and N-methylpyrrolidone.

9. The polythiophene-based conductive polymer layer according to claim 4, wherein the aprotic highly dipolar solvent is one or more selected from dimethylsulfoxide and propylene carbonate.

10. The polythiophene-based conductive polymer layer according to claim 4, wherein, when the aprotic highly dipolar solvent is used, a dispersion stabilizer is added in an amount of 1 to 10 wt % based on the polythiophene-based conductive solution composition.

11. The polythiophene-based conductive polymer layer according to claim 10, wherein the dispersion stabilizer is one or more selected from ethylene glycol, glycerine and sorbitol.

12. The polythiophene-based conductive polymer layer according to claim 4, wherein the binder is one or more selected from methyltrimethoxysilane and tetraethoxysilane.
